(19) United States
(12) Patent Application Publication
(10) Pub. No.: US 2005/0277856 A1
(43) Pub. Date: Dec. 15, 2005

(54) Method and apparatus for alleviating deep vein thrombosis (DVT) and other circulatory conditions

(76) Inventor: A. Sandy Munro, Troy, MI (US)

Correspondence Address: HARNESS, DICKEY & PIERCE, P.L.C., P.O. BOX 828, BLOOMFIELD HILLS, MI, 48303, US

(21) Appl. No.: 11/120,094

(22) Filed: May 2, 2005

Related U.S. Application Data
(60) Provisional application No. 60/572,313, filed on May 18, 2004.

(51) Int. Cl. A61H 1/00

(52) U.S. Cl. 601/57; 601/49

(57) ABSTRACT

A method of treating a user seated in a seat to reduce the likelihood of deep vein thrombosis (DVT). The method includes providing a vibrator, locating the vibrator in proximity to a lower extremity of the user, and applying a vibratory stimulus to a portion of the lower extremity of the user with the vibrator.

### CROSS-REFERENCE TO RELATED APPLICATIONS

This application claims the benefit of U.S. Provisional Application No. 60/572,313 filed on May 18, 2004. The disclosure of the above application is incorporated herein by reference.

### INTRODUCTION

Deep vein thrombosis (DVT) refers to a potentially fatal condition which tends to afflict passengers on extended travel or other persons in situations associated with prolonged immobility of the lower extremities.

Deep vein thrombosis is the formation of blood clots in the veins of the leg. One of the main causes of DVT is restricted blood flow. Long distance travelers, including but not limited to air passengers, are particularly vulnerable to DVT because they are more likely to sit immobile for long periods of time.

Air travelers are particular vulnerable, given the relatively cramped quarters in commercial airplanes. Members of the following groups are at particular risk for DVT: those with thrombophilia (heightened tendency towards clotting); those recovering from recent surgery or injury; those with a history of heart or lung trouble; those with a history of cancer; women using oral contraceptives or hormone replacement therapy; pregnant women; those aged over 40; those with recent medical illness; overweight people; heavy smokers; heavy drinkers; and those prone to dehydration.

Various recommendations have been provided for prevending or reducing the risk of DVT. For example, it is recommended to wear surgical stockings and to stand up and take a brief walk or do some leg stretching exercises. This walking or stretching should be done every 90-120 minutes, if possible. Other recommendations include breaking ultra long-haul journeys into multiple segments, e.g. spending a night in Southeast Asia before flying on to or back from Australia.

While some recommendations to avoid DVT are more practical than others, all require a positive action by the passenger. For this reason, the passenger must be aware of the risk of DVT and must also be willing to take precautionary and or proactive measures before and/or during travel.

Accordingly, there is a need for cost-efficient devices and associated methods for passively reducing the likelihood of deep vein thrombosis.

### SUMMARY

The present teachings provide a method of treating a user seated in a seat to reduce the likelihood of deep vein thrombosis (DVT). The method includes providing a vibrator, locating the vibrator in proximity to a lower extremity of the user, and applying a vibratory stimulus to a portion of the lower extremity of the user with the vibrator.

The present teachings also provide a device for treating a user seated in a seat to reduce the likelihood of deep vein thrombosis (DVT). The device includes a vibrator for producing a vibratory stimulus associated with the seat, and a control module for selectively applying the vibratory stimulus to a lower extremity of the user. Selective application of the vibratory stimulus to the lower extremity of the user improves circulation of the lower extremity and thereby reduces the likelihood of DVT.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an environmental view of an exemplary anti-DVT device according to the present teachings, the device shown operatively associated with a seat and a passenger or other user;

FIG. 2 is a diagram illustrating operational components of an exemplary anti-DVT device according to the present teachings; and

FIG. 4 is a flow diagram illustrating aspects of an exemplary anti-DVT method according to the present teachings.

### DETAILED DESCRIPTION

The following description is merely exemplary in nature and is in no way intended to limit the invention, its application, or uses.

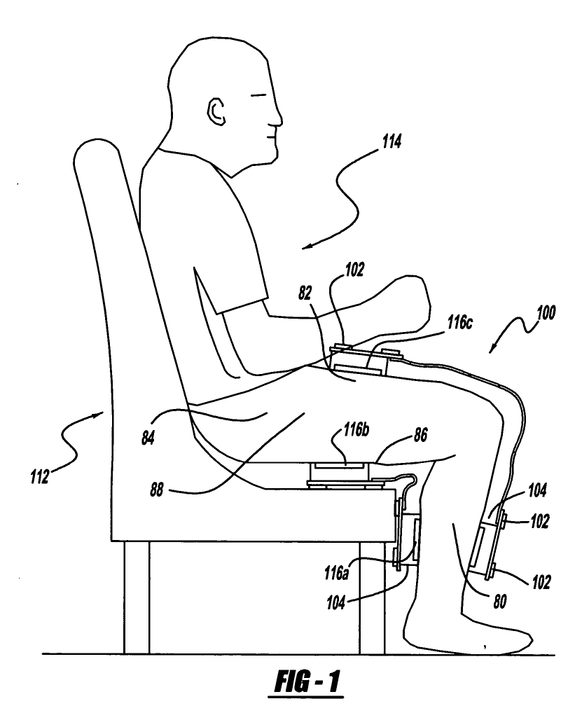

With initial reference to FIG. 1, an exemplary anti-deep vein thrombosis (“anti-DVT”) device according to the present teachings is illustrated and generally identified at reference character 100. The anti-DVT device 100 is shown operatively associated with a seat 112 and a seated passenger or other user 114. The seat 112 can be a seat of an airplane, bus, train, automobile, truck or other transportation means, although the present teachings are not limited to travel applications. In this regard, the seat 112 can also be an office chair, a wheel chair or other chair or seat on which a person is seated over long periods at a time for various reasons, including job-related or disability-related reasons.

The anti-DVT device 100 is shown located in close proximity to a lower extremity 88 of the seated user 114. More specifically, the anti-DVT device 100 can be positioned below the seated user 114 adjacent the thighs 84 of the user 114. In the exemplary illustration of FIG. 1, the anti-DVT device 100 can extend downwardly along a front edge of the seat 112 and can include portions additionally positioned adjacent an upper portion of the calves 80. The anti-DVT device 100 can also include portions directed to an anterior thigh surface 82, and posterior and/or lateral (or medial) thigh surfaces 86. Alternatively, separate anti-DVT devices 100 can be provided for each targeted portion of the user's lower extremity 88.

The anti-DVT device 100 can be removably or permanently placed relative to the seat 112, for example on the seating surface of the seat 112 or along a side or edge or other portion of the seat 114. The anti-DVT device 100 can include fastening means 102, including, but not limited to, hook and loop fasteners, such as Velcro®, for securing the anti-DVT device in place relative to the seat 112, and, optionally, around the thigh 84 or calf 80 of the user 114. Alternatively, the anti-DVT device 100 can be permanently secured to the seat 112 and, optionally, removably secured relative to the user 114, around the calf 80, for example.

The anti-DVT device 100 can be operable for producing a mechanical vibratory stimulus, such as a localized vibratory massage. The strength of the vibratory stimulus can be adjustable to suit the particular needs of the user 114 using known control devices and methods. As will be discussed below, the strength of the vibratory stimulus can be adjusted according to a characteristic of the particular user 114 seated on the seat 112.

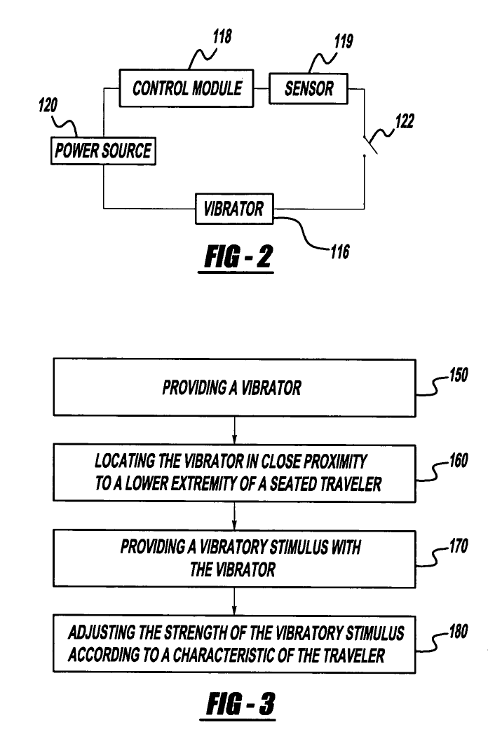

With continued reference to FIG. 1 and additional reference to FIG. 2, the anti-DVT device 100 can generally include a vibrator 116 for providing a vibratory stimulus, a control module 118 for controlling the vibrator 116, and a power source 120 for powering the vibrator 116. The power source 120 can be a removable or a rechargeable battery source. The power source 120 can also be connected to a main power supply, such that the vibrator 116 can be powered directly or indirectly through an electric system associated with the vehicle, house, hospital, or office, depending on the particular application. The vibrator 116 can include a single or multiple vibrator portions, such as any of those illustrated by reference numerals 116a, 116b, 116c, although fewer or additional vibrator portions can be included. The vibrator portions 116a, 116b, 116c can be globally or individually controlled, either automatically, or selectively by the user, to provide localized vibratory stimulus.

The control module 118 can operate for controlling the vibrator 116. More specifically, the control module 118 can control opening and closing of a switch 122. When the switch 122 is closed, the vibrator 116 produces and delivers the vibrating stimulus to the user 114. It will be appreciated that a single switch 122 can be used to control all the vibrator portions 116a, 116b, 116c, although separate switches 122 can also be used for each of the vibrator portions 116a, 116b, 116c. When the switch 122 is open, as shown in FIG. 2, no vibrating stimulus is produced by the vibrator 116. The control module 118 can operate in a conventional manner to cyclically open and close the switch 122 for cyclically delivering the vibrating stimulus to the user 114. In this regard, it is not necessary to continuously deliver the vibratory stimulus to the user 114. For energy-conserving purposes, for example, the control module 118 can operate in active mode or in sleep (non-active) mode, either in an automatic (passive) mode or by selective activation by the user. The control module 118 can also operate to selectively activate one or more of the vibrator portions 116a, 116b, 116c.

The control module 118 can include a conventional microprocessor, a programmable logic controller, or other known control devices that can operate the vibrator 116 automatically or with active user input. The control module 118 can include, when desired in a particular application, a visual display, and various user-operable control, input, and/or selector buttons, including, for example, on and off buttons, intensity selector buttons, duration selector buttons, mode selector buttons, such as sleep mode, manual mode, automatic mode, or other control or input buttons. The control module 118 can also include adjustability means for a particular characteristic of a user 114. In certain applications, the control module 118 can include, for example, a sensor 119 for sensing a body weight or a body mass index (BMI) or other body or weight or size or mass characteristic of the user 114. The sensor 119 can send a signal to the control module 118. In response to the signal, the control module 118 can automatically adjust the strength of the vibrator stimulus according to the characteristic of the user 114. In this manner, a stronger stimulus can be delivered to heavier/bigger passengers and a weaker stimulus can be delivered to lighter/smaller passengers. Alternatively or additionally, the sensor 119 can function to adjust the cyclical operation of the switch 122, such that the switch 122 is closed for a longer period of time for heavier/bigger passengers. The sensor 119 can also function to adjust both the strength of the vibratory stimulus and the period of operation. For manual/active control by the user 114, the sensor 119 can be also bypassed. Alternatively, sensor information can be supplemented by user input, such as age, gender or other relevant information, enabling the control module 118 to provide a user-customizable vibratory stimulus schedule by varying duration and strength according to inputs received. Relevant algorithms based on empirical data can be included in the control module 118 for producing such customized schedules.

As discussed above, the anti-DVT device 100 can function either passively in an automatic mode, actively by user input and participation, or in a combined mode. In the passive mode, for example, the anti-DVT device can function automatically without any positive input required by the user 114. In this manner, the benefits of the anti-DVT device 100 can be obtained without any reliance on the passenger 114 for its operation. In certain applications, however, it may be desirable to provide the passenger 114 with control that overrides the automatic operation of the control module 118, such that the anti-DVT device can operate in active/manual or semi-automatic mode. In this regard, the vibrator 116 can provide desired relaxation for short or extended periods of use. Similarly, the passenger 114 can control the strength of the vibratory stimulus.

Referring to FIG. 3, an exemplary method for preventing or reducing the risk of DVT according to the present teachings is illustrated. The method can include providing a vibrator, as illustrated at aspect 150. The vibrator 116 described above in reference to FIGS. 1 and 2, or other known vibrators 116, can be used. Referring to FIGS. 1 and 3, the vibrator 116 can be located in close proximity to the lower extremity 88 of a seated user 114, as illustrated at aspect 160. The vibrator 116 or vibrator portions 116a, 116b, 116c can be positioned adjacent the posterior surfaces of the user's legs. More particularly, the vibrator portions 116a, 116b, 116c can be positioned to apply vibration the user's thighs and to an upper portion of the user's calves, or other portions of the lower extremity of the user 114.

The vibrator 116 can produce a vibratory stimulus, as illustrated as aspect 170. As discussed above, the stimulus can be produced in a passive or fully automatic mode without any passenger input, although semi-automatic and manual modes can also provided for at least partial control by the user 114.

The strength of the vibratory stimulus can adjusted according to a characteristic of the user 114, as illustrated at aspect 180. The strength of the vibratory stimulus can be adjusted, for example, according to a sensed weight or a sensed body mass index (BMI) of the user 114. The vibratory stimulus can be expected to provide a pleasant and relaxing sensation, improve circulation and at least reduce the risk of deep vain thrombosis for users experiencing long periods of immobility in their lower extremities.

The description of the invention is merely exemplary in nature and, thus, variations that do not depart from the gist of the invention are intended to be within the scope of the invention. Such variations are not to be regarded as a departure from the spirit and scope of the invention.

1. A method of treating a user seated in a seat to reduce the likelihood of deep vein thrombosis (DVT), the method comprising:
providing a vibrator;
locating the vibrator in proximity to a lower extremity of the user; and
applying a vibratory stimulus to a portion of the lower extremity of the user with the vibrator.

2. The method of claim 1, wherein applying a vibratory stimulus comprises applying a cyclic vibratory stimulus.

3. The method of claim 1, wherein applying a vibratory stimulus comprises automatically applying vibration according to a predetermined schedule including periods of vibration and periods of non-vibration.

4. The method of claim 1, wherein the vibrator is powered by a battery source.

5. The method of claim 1, wherein the vibrator is permanently associated with the seat.

6. The method of claim 1, wherein the vibrator is removably permanently associated with the seat.

7. The method of claim 1, wherein applying a vibratory stimulus comprises selectively applying a vibratory stimulus to different portions of the lower extremity of the user.

8. The method of claim 1, further comprising adjusting a strength of the vibratory stimulus according to a characteristic of the user.

9. The method of claim 8, further comprising adjusting a strength of the vibratory stimulus according to a weight or mass characteristic of the user.

10. The method of claim 8, further comprising sensing an approximate weight or mass of the user and adjusting a strength of the vibratory stimulus according to the approximate weight or mass characteristic.

11. A device for treating a user seated in a seat to reduce the likelihood of deep vein thrombosis (DVT), the device comprising:
a vibrator for producing a vibratory stimulus associated with the seat; and
a control module for selectively applying the vibratory stimulus to a lower extremity of the user;
whereby selective application of the vibratory stimulus to the lower extremity of the user improves circulation of the lower extremity and thereby reduces the likelihood of DVT.

12. The device of claim 11, wherein the vibrator includes a plurality of separate vibrator portions.

13. The device of claim 12, wherein the vibrator portions are selectively activated by the control module.

14. The device of claim 11, wherein selective application of the vibratory stimulus includes cyclic application of the vibratory stimulus.

15. The device of claim 11, wherein the vibrator is permanently associated with the seat.

16. The device of claim 11, wherein the vibrator is removably associated with the seat.

17. The device of claim 11, further comprising a battery for powering the vibrator.

18. The device of claim 11, wherein the vibrator is operable to produce a vibratory stimulus having a variable strength.

19. The device of claim 18, wherein the control module automatically adjusts the variable strength of the vibratory stimulus according to a characteristic of the user.

20. The device of claim 18, further comprising a sensor for sensing an approximate weight or mass of the user, the sensor operative to deliver a signal to the control module, the control module operative to adjust the strength of the vibratory stimulus in response to the signal.

21. The device of claim 11, wherein the control module is operable to provide a customizable schedule of vibratory stimulus to the user.
